(19) United States
(12) Patent Application Publication
(10) Pub. No.: US 2017/0139679 A1
(43) Pub. Date: May 18, 2017

(54) METHODS AND APPARATUS USING A NODE GRAPH ARCHITECTURE

(71) Applicant: KING.COM LIMITED, St. Julians (MT)

(72) Inventor: Christian Murray, Stockholm (SE)

(21) Appl. No.: 14/944,634

(22) Filed: Nov. 18, 2015

(51) Int. Cl. G06F 9/44; G06F 11/36; G06F 12/08

(52) U.S. Cl. CPC G06F 8/30; G06F 12/0802; G06F 8/24; G06F 11/3604; G06F 2212/1032; G06F 2212/60

(57) ABSTRACT

A node graph architecture has nodes with arc between the nodes. The architectures arranged to so that for each change made to data of a node, a full history of the node graph architecture is stored. The history comprises state which is data of the nodes and the arc. When an undo function is applied, the state of the node architecture reverts to the state of one of the stored full histories.

### FIELD OF THE INVENTION

Some embodiments may relate to methods and apparatus using a graph node architecture.

### BACKGROUND OF THE INVENTION

Graph architecture or node graph architecture is often used in a wide range of applications to reduce the complexity of software design. Node graph architecture is made up a series of nodes which perform a specific task and are connected to other nodes to provide and/or receive data therefrom. Graph architecture is used, for example in the computer games industry.

When changes are being made to data of a node, using a software editor, it may be desirable to be able to undo changes which are being made in a straightforward manner.

### SUMMARY OF THE INVENTION

According to an aspect there is provided a computer implemented method comprising: responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs; responsive to a further change in data in the node graph architecture, storing in the memory a second full history of the graph; and applying an undo function such that a current state of the node graph architecture reverts to the state of the first history.

A data structure of the node graph architecture may comprise a persistent immutable data structure.

At least two of the histories may share at least some data structures.

The method may comprise storing, for each change in data a further full history of the graph.

n full histories may be stored and using the undo function a mth full history may provide a current state of the node graph architecture, the method may be responsive to a further change to the mth full history, to delete any history which occurred in time after an initial occurrence of the mth full history.

The method may comprise applying a redo function such that a state of the node graph architecture changes to a state of the graph history which occurred subsequent to the initial occurrence of a current graph history.

The state information may comprise cache data comprising an output value of a node and validity information indicating if the output value is valid, the undo function causing the cache data to revert to a respective value in the respective history.

Each history may be stored with identification information.

The method may comprise determining a plurality of output data in response to input data in a respective node; storing the plurality of output data in a cache memory with information indicating the validity of the respective data; editing at least one node such that at least one of the respective output data is changed; and causing the information indicating the validity of the data which is changed to indicate that the data is invalid.

The method may comprise using information about dependencies, the dependencies providing information about which used outputs from one or more other nodes a respective node at least one of directly and indirectly uses, the information being used when the respective node is required to provide an output to check the validity information associated with the used outputs and determining from the validity information if the used output data in the cache memory is to be used.

The method may comprise selecting data used by a current node, the current node using output data from a plurality of different nodes, each of the output data comprising information identifying the node which provided the output data, said selected data being one of said output data; and using the identifying information to perform editing of the selected data in the node of the different nodes which provided the data while viewing the data in the node.

According to another aspect, there is provided a method comprising; in a node graph software architecture, determining a plurality of output data in response to input data in a respective node; storing the plurality of output data in a cache memory with information indicating the validity of the respective data; editing at least one node such that at least one of the respective data which will be output by said node is changed; causing the information indicating the validity of the respective data which is changed to indicate that the respective data is invalid.

The method may comprise using information about dependencies, the dependencies providing information about which used outputs from one or more other nodes a respective node at least one of directly and indirectly uses, the information being used when the respective node is required to provide an output to check the validity information associated with the used outputs, the validity information being used to determine if the used output data in the cache memory is to be used

The method may comprise selecting data used by a current node, the current node using output data from a plurality of different nodes, each of the output data comprising information identifying the node which provided the output data, said selected data being one of said output data; and using the identifying information to perform editing of the selected data in the node of the different nodes which provided the data while viewing the data in the node.

According to another aspect, there is a method comprising: selecting data when viewing a node in a node graph architecture, the node using output data from a plurality of different nodes, each of the output data comprising information identifying the node which provided the output data; and using the identifying information to perform editing of the data in the node which provided the data while viewing the data in the node.

According to another aspect, there is provided a computer program comprising computer executable instructions which when run cause any of the method set out previously to be performed.

The computer executable instructions may be run on one or more processors

According to another aspect, there is provided a computer program product, comprising a computer readable storage device having a computer readable program code stored therein, said computer readable program code containing instructions configured to be executed by at least one processor to implement a method, said method comprising: responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs; responsive to a further change in data in the node graph architecture, storing in the memory a second full history of the graph; and applying an undo function such that a current state of the node graph architecture reverts to the state of the first history.

According to another aspect, there is provided a computer program product, comprising a computer readable storage device having a computer readable program code stored therein, said computer readable program code containing instructions configured to be executed by at least one processor to implement a method, said method comprising: selecting data when viewing a node in a node graph architecture, the node using output data from a plurality of different nodes, each of the output data comprising information identifying the node which provided the output data; and using the identifying information to perform editing of the data in the node which provided the data while viewing the data in the node.

According to another aspect, there is provided a computer program product, comprising a computer readable storage device having a computer readable program code stored therein, said computer readable program code containing instructions configured to be executed by at least one processor to implement a method, said method comprising: in a node graph software architecture, determining a plurality of output data in response to input data in a respective node; storing the plurality of output data in a cache memory with information indicating the validity of the respective data; editing at least one node such that at least one of the respective output data is changed; causing the information indicating the validity of the data which is changed to indicate that the data is invalid.

According to another aspect, there is provided a data processing apparatus comprising at least one processor and at least one memory coupled to the processor, said at least one memory having program code configured to be executed by the at least one processor to implement a method, said method comprising: responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs; responsive to a further change in data in the node graph architecture, storing in the memory a second full history of the graph; and applying an undo function such that a current state of the node graph architecture reverts to the state of the first history.

A data structure of the node graph architecture may comprise a persistent immutable data structure.

At least two of the histories may share at least some data structures.

The at least one memory may be configured to store, for each change in data a further full history of the graph.

n full histories may be stored and using the undo function a mth full history may provide a current state of the node graph architecture, the at least one processor may be responsive to a further change to the mth full history, to delete any history from said memory which occurred in time after an initial occurrence of the mth full history.

The processor may be configured to apply a redo function such that a state of the node graph architecture changes to a state of the graph history which occurred subsequent to the initial occurrence of a current graph history.

The state information may comprise cache data comprising an output value of a node and validity information indicating if the output value is valid, the undo function causing the cache data to revert to a respective value in the respective history.

Each history may be stored with identification information.

The at least one processor may be configured to determine a plurality of output data in response to input data in a respective node; a cache memory of said at least one memory being configured to store a plurality of said output data in a cache memory with information indicating the validity of the respective data; at least one processor may be configured to edit at least one node such that at least one of the respective output data is changed and to cause the information indicating the validity of the data which is changed to indicate that the data is invalid.

The at least one processor may be configured to use information about dependencies, the dependencies providing information about which used outputs from one or more other nodes a respective node at least one of directly and indirectly uses, the information being used when the respective node is required to provide an output to check the validity information associated with the used outputs and to determine from the validity information if the used output data in the cache memory is to be used.

The at least one processor may be configured to select data used by a current node, the current node using output data from a plurality of different nodes, each of the output data comprising information identifying the node which provided the output data, said selected data being one of said output data; and to use the identifying information to perform editing of the selected data in the node of the different nodes which provided the data while viewing the data in the node.

According to another aspect, there is provided a data processing apparatus comprising at least one processor and at least one memory coupled to the processor, said at least one memory having program code configured to be executed by the at least one processor to implement a method, said method comprising: selecting data when viewing a node in a node graph architecture, the node using output data from a plurality of different nodes, each of the output data comprising information identifying the node which provided the output data; and using the identifying information to perform editing of the data in the node which provided the data while viewing the data in the node.

According to another aspect, there is provided a data processing apparatus comprising at least one processor and at least one memory coupled to the processor, said at least one memory having program code configured to be executed by the at least one processor to implement a method, said method comprising: in a node graph software architecture, determining a plurality of output data in response to input data in a respective node; storing the plurality of output data in a cache memory with information indicating the validity of the respective data; editing at least one node such that at least one of the respective output data is changed; causing the information indicating the validity of the data which is changed to indicate that the data is invalid

In the above, many different embodiments have been described. It should be appreciated that further embodiments may be provided by the combination of any two or more of the embodiments described above.

Various other aspects and further embodiments are also described in the following detailed description and in the attached claims.

### BRIEF DESCRIPTION OF FIGURES

To understand some embodiments, reference will now be made by way of example only to the accompanying drawings, in which:

FIG. 1 shows a computing arrangement in which embodiments may be provided;

FIG. 2 schematically shows a graph architecture used in embodiments;

FIG. 3 shows a schematic representation of a node in the graph of FIG. 2;

FIG. 4 shows schematically a cache memory used in some embodiments;

FIG. 5 schematically shows the relationship between the graph and an editor;

FIG. 6 schematically shows a method flow, illustrating an undo function according to an embodiment;

FIG. 7 shows a method of invalidating cache data;

FIG. 8 schematically shows inputs and outputs of an example node;

FIG. 10 schematically shows a first example of caching and value changes;

FIG. 11 schematically shows a second example of caching and value changes;

FIG. 12 schematically shows using production functions; and

FIG. 13 shows a method of in-line editing.

### DETAILED DESCRIPTION

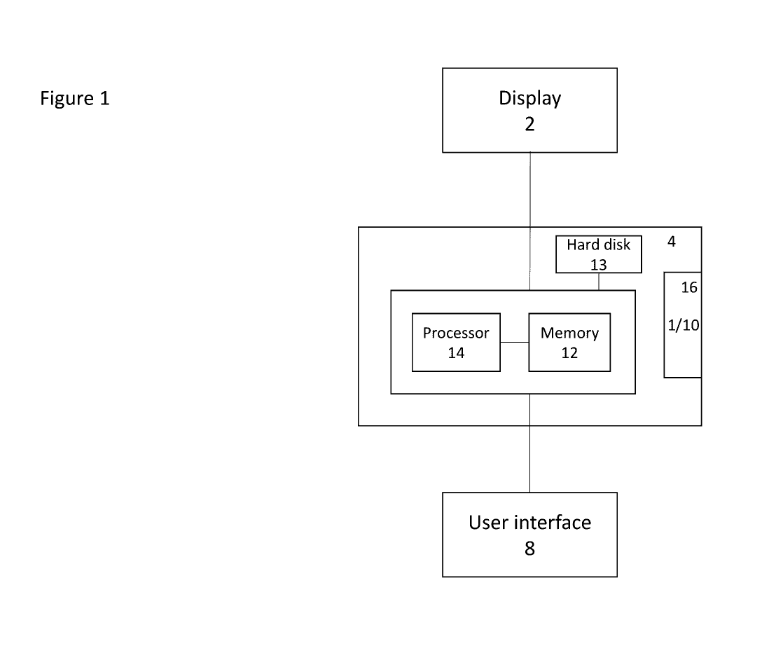

Reference is made to FIG. 1 which schematically shows a computing arrangement 1 in which embodiments may be provided. In this example, the computing arrangement may be a PC, laptop or the like. The computing arrangement comprises a computing part 4 which comprises a processing part 10. The processing part may in some embodiments be provided by a CPU (central processing unit). This processing part 40 comprises one or more processers 14 along with one or more memories 12. The one or more memories 12 may comprise random access memory, in some embodiments.

The computing part may have an input/output interface which allow the apparatus to be connected to a network and/or one or more other devices. The input/output interface may be wired and/or wireless.

In this embodiment, a hard disk drive 13 or other similar data storage may be provided. In other embodiments, the hard disk drive or other data storage may be provided on a different device. The computing part may be configured to access the different device via the input/output interface 6. This may directly or via a network or the like.

The computing arrangement may have a display coupled to the computing part 4. The display is, in some embodiments, driven by the computing part 4.

The computing arrangement comprises a user interface 8. That user interface can be any suitable interface such as a keyboard and/or a user touch screen. In some embodiments, the user interface may comprise a mouse or other pointing device.

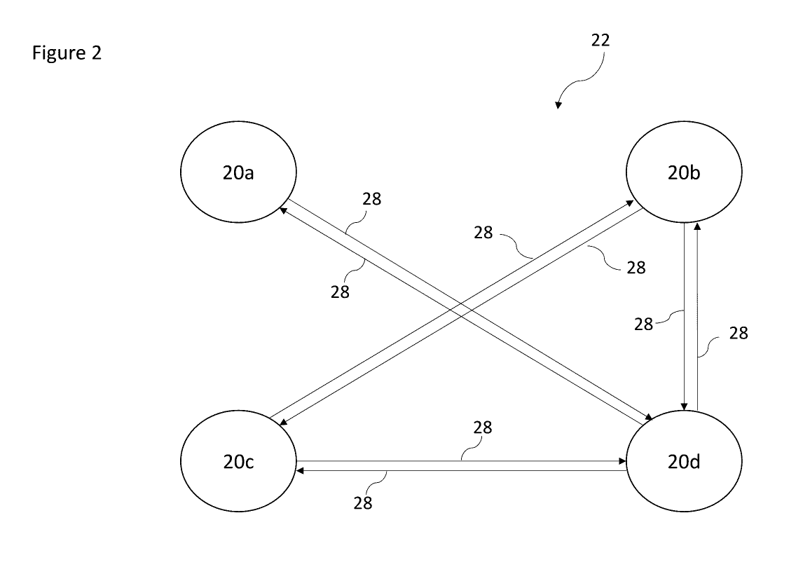

Reference is made to FIG. 2 which schematically shows a graph architecture 22 which is used in some embodiments. The graph architecture comprises a plurality of nodes or vertices. In the example shown in FIG. 2 there are four nodes or vertices 20a, 20b, 20bc and 20d. It should be appreciated that in practice there will be many more than the four nodes shown. Each node is connected to at least one other node by a so-called arc or an edge. The architecture and computational model used in some embodiments is a bidirectional graph, where computed data flow in one direction (forward) and dependencies are traced in the opposite direction (backward). The nodes hold the data. The nodes are connected through arcs which pass on the computed data. It should be appreciated that a node may have a loop where the node provides both ends of an arc. A node nodes performs instructions with respect to input data to provide output data.

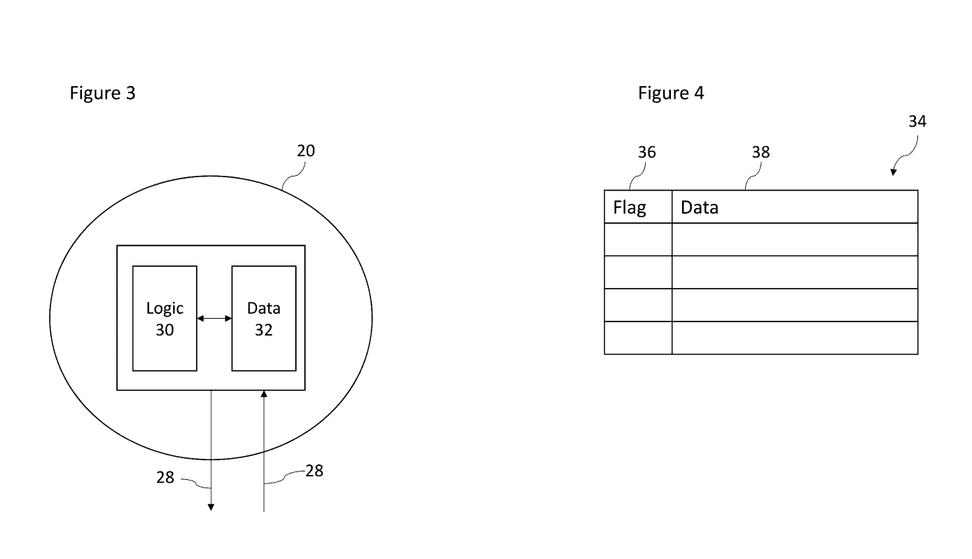

Reference is made to FIG. 3 which is schematically shows a node 20. The node will have some logic associated with it as well as data 32. The logic may receive data from another node via arc 28, process that data or use that data to provide data which can be output via another arc 28. An output of a node is defined through the incoming data needed to compute the result for that specific output. A node may have two or more outputs which send data, along the respective arc, to the associated consuming node. The inputs are labelled typed inputs and the outputs maybe labelled typed outputs.

Thus, the nodes can be considered to hold the data and the arcs are able to pass on the computed data. It should be appreciated that an arc will be associated with particular data which is required by a different node, on the output side. Likewise on the input side each arc is associated with a particular piece of data which is required by that node.

In some embodiments, a node may have a single input arc and/or a single output arc. However, in some embodiments, more than one input/output arc may be provided. The arcs may be provided to the same or different nodes. Thus an arc will provide a particular input required by the logic. If the logic requires two inputs, two separate arcs are required, one of each of the particular inputs. For example, node 20c has an output arc to node 20b and to node 20d. The two arcs can provide the same data to node 20b and 20d or can each provide different data.

The logic perform instructions or operations with respect to input data. The logic supports different functions which can be selected or deselected via editing software as will be discussed later. Alternatively or additionally the functions may be modified by the editing software.

In some embodiments, the system will support more than one graph. In other words, two or more graphs such as shown in FIG. 2 may be provided. Thus, there may be one or more arcs from one or more nodes in one graph to one or more nodes in a different graph.

There are many different examples of uses of a graph node. Some examples will now be provided in the context of a computer implemented game and in particular the process of developing the software for a game. However, it should be appreciated that this is only one example where embodiments may be used. Embodiments may be used in any computer software application which uses a graph architecture.

Some embodiments may have particular application to arrangements where a graph architecture is editable using for example, editor software. Each node may form a specific tasks. The nodes can be used to generate one or more of path planning, sending of signals between game entities, procedural modelling, animation, rendering etc.

Some embodiments may simplify data dependencies.

Some embodiments may allow one or more nodes to be copied so as to reuse complex computations.

Some embodiments may allow a live game tool development.

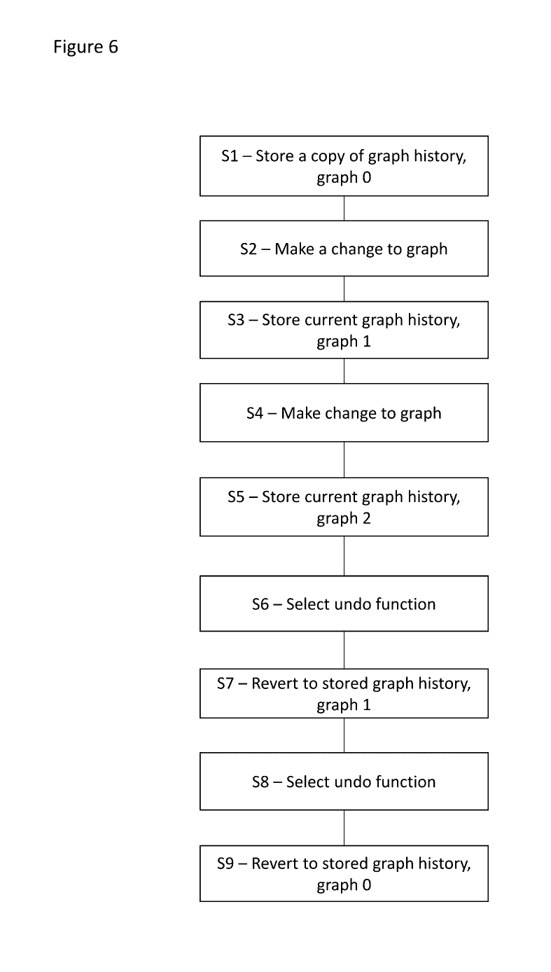

Reference is made to FIG. 5 which schematically shows the hierarchy of the software. When wanting to make changes to an underlying graph 22, editor software 50 is typically provided. That editor software 50 is able to make certain types of changes which result in changes in the output data of one more nodes. Generally these are not changes to the underlying logic itself but changes to functions provided by that logic. The functions of the editor software are generally editing functions. The action of the user via the editor will make changes to the functions provided by one or more nodes.

Consider the simplified example which is provided to illustrate some embodiments. In practice, a graph may have many more nodes in embodiments. The nodes can provide any suitable function.

A first node is configured to provide an output which is data defining the appearance of a hat. The node can be edited via the editor software to have a different appearance for the hat. The output of that first node will be data defining the hat.

A second node is provided. There is an arc from the first node to the second node which provides the hat output from the first node to the second node. The second node is configured to provide an image of a character. The second node will provide an output to a third node. The output provided on an arc from the second node to the third node will be data which defines the character with the hat.

The third node will receive the data from the second node. The third node will provide as an output an image of the character with a hat in a scene.

With previous systems, in order to support an undo function, each transformation would be provided with an undo function. The transformation function would thus be able to make a required change (for example to delete). The transformation function would also include an undo transformation which would allow the change to be undone. However, requiring each transformation to have a corresponding undo function introduces complexity into the system resulting in for example bugs in the software. Some embodiments may avoid this problem.

In embodiments, a full history of a graph is recorded after each change. This data is stored in the memory. Preferably the history is stored in the memory 12 and not the disk, but in some embodiments, it is possible that the history could be stored to disk.

The history is made up of all states of the graph. The state is both the data of the nodes, in combination with the arcs between them.

The incoming data is used for dependency tracing, which collects all data needed to compute a certain value. The dependency is known and is the information which describes the relationships between the nodes, that is what data is provided by each node and to which node. The dependency information provides information as to which data a node needs and from which node. By repeating this process on the incoming data, it is possible to follow the graph backwards and find all data needed to compute a certain value.

The dependency information is known by the editor software in some embodiments.

The dependency information may provide perfect caching as will be discussed later.

On example of such a value can be the game bundle (IPA file-an IPA files is an iOS App file for Apple devices) sent to the App Store for game submission. The incoming data for that value is the entire project content, i.e. the entire game.

Another value might be the graphics to render a part of the project inside the editor. Then only a subset is needed for that computation.

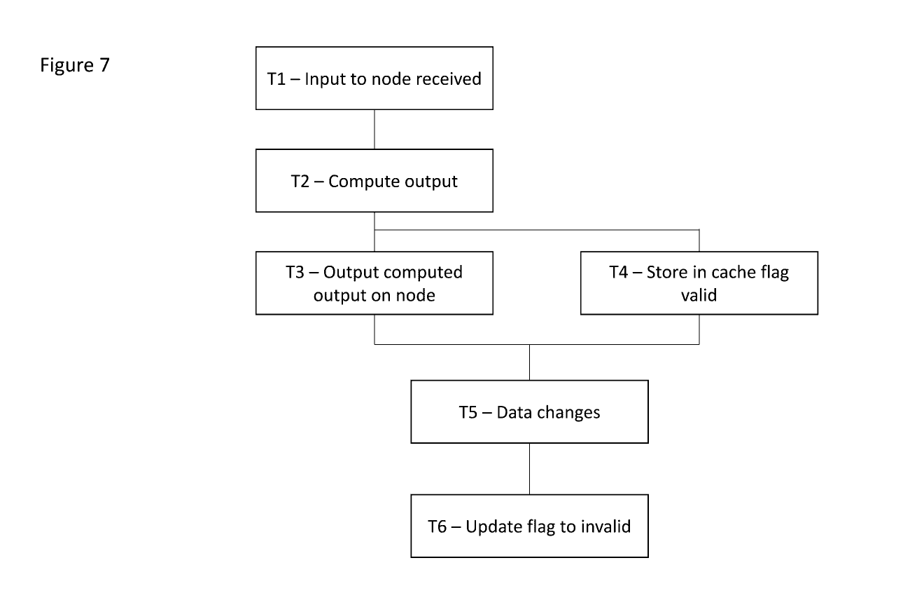

In some embodiments an undo function is supported. Reference is made to FIG. 6 which shows a method flow of an embodiment.

In step S1, a full copy of the graph history is stored, graph 0.

In step S2, a change is made to the graph. For example, the simple example described previously, a user may via the editor software change the hat.

In step S3, the updated graph history is stored, graph 1. There are now two separate graph histories stored, graph 0 and graph 1. Both of these graph histories can be considered to be full graph histories.

In step S4, a change is made to the graph. For example, the simple example described previously, a user may via the editor software change the appearance of the character.

In step S5, the updated graph history is stored, graph 2. There are now three separate full graph histories stored.

In step S6, the user selects via the editor software an undo function.

In step S7, the graph will revert to the previous graph, graph 1. The state of the graph will therefore be as if the previous change had not been made. It should be appreciated that the state information is retained as it is stored as part of the graph history. Consider the following example. A user highlights a set of game elements for deletion from a game board and then deletes those game elements. The history information will store the graph which has the game elements prior to their deletion as well as the selection of those game elements. Thus the state information allows the user to revert to the state of the graph when the undo function is selected and the selection of the objects prior to their deletion is provided.

In step S8, the user selects via the editor software the undo function. It should be appreciated that this is optional and in some embodiments, a user instructs the software editor to only do a single undo function before making some further changes.

In step S9, the graph will revert to the previous graph to the current graph which is now graph 1. The graph will therefore be graph 0.

Steps S8 and S9 can be repeated as required.

In some embodiments, the system can be configured to store n graph histories where n is an integer. In some embodiments, the undo function can therefore be invoked n-1 times. N can be any suitable integer and can be order of between 5 and 10. In some embodiments n can be much larger and say between 1 and 100. Other embodiments may have greater than 100 histories stored. In other embodiments, n can be between 1 and 5.

Consider the following example. After step S9, the user decides to make a change to current graph, graph 0. In some embodiments, when this happens, graphs 1 and 2 will be removed from memory. In some embodiments when a change is made to a graph, any subsequent graph histories to the current graph being edited may be deleted.

In some embodiments, each graph history has an indicator such as an integer. When a graph history having an integer of a is edited, any graph history with an integer greater than a is deleted.

In some embodiments a change may be to add or to remove one or more nodes from the graph.

Reference is made to FIG. 9 which schematically shows a first graph 900, the history of which is stored. A transaction 902 occurs in response to GUI events 906 which provides an update/new graph 904 which is also stored. The new graph updates GUI controls 908 in this example.

Some embodiments may use a programming language which has for example immutable data structures. The language may use structural sharing to ensure that small changes only require a small amount of additional space as well as keeping an entire history. The data structures may be persistent. Some data structures are ephemeral in the sense that making a change to the structure destroys the old version, leaving only the new one. In contrast some embodiments use a fully persistent data structure which supports access to multiple versions.

In an example a value x (data output by a node for example) is a constant. If the data output by a node changes this is a different value y. The value x is a different value to y and is immutable. For example, the “x” is a value and the value “x” cannot be set to some other value; it always stays the value “x”. It is immutable. If y is to be used instead of x, a new value y is provided.

One example of a programming language which can be used in some embodiments is Clojure.

In Clojure, all scalars and core data structures are values. They are immutable. The map associated with a node output

{:name “bear”
:hit-points 200}

is a value. If the hit-points are “changed”, a new hash map value is determined, rather than changing the map, a new hash map value is determined.

The use of immutability allows the sharing of data structures. The program can keep track of all their pieces and re-uses them pervasively. This means that after each change a “full copy” of the history is stored but the memory usage required to store each of these copies is relatively small. This is different from the memory arrangements which store only changes between histories. This means that if the user wishes to revert graph x-2, that could be done without having to go through the states defined by x-1.

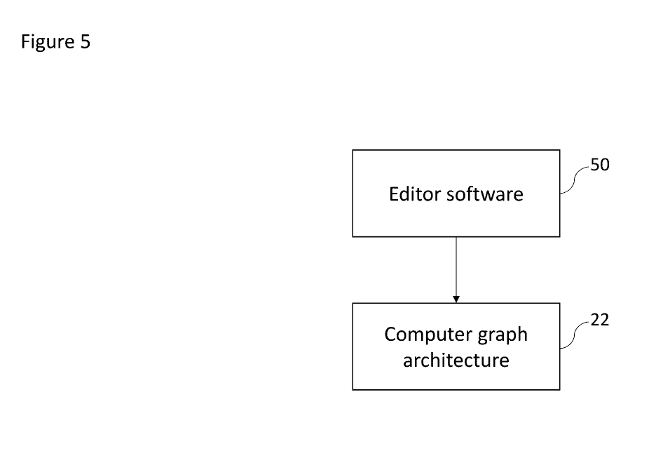

FIG. 4 shows a cache memory used in some embodiments. The cache memory may be part of the one or more memories referenced in FIG. 1. An output of a one or more nodes may be cached. This means that as long as the incoming data for that output does not change, the computed value can be fetched from cache memory rather than being recomputed. If any of the incoming data changes, the value will need to be recomputed as it can potentially be different. Accessing the data may be quicker than re-computing the output in a node.

A cache hit occurs when the requested data can be found in a cache, while a cache miss occurs when it cannot. Cache hits are served by reading data from the cache, which is faster than re-computing a result.

The cache memory 34 stores the output or data 38 along with flag 36.In some embodiments optionally node identification information associated with a node may be stored as part of the entry with the data and the flag. A flag 36 is provided for each output or data. The flag 36 may be a bit which has one state when the cached data is valid and a different value when the cached data is considered to be stale or invalid. In some embodiments, the flag is set to one when the data is in valid and zero if the data is invalid. Of course the opposite may be true in other embodiments.

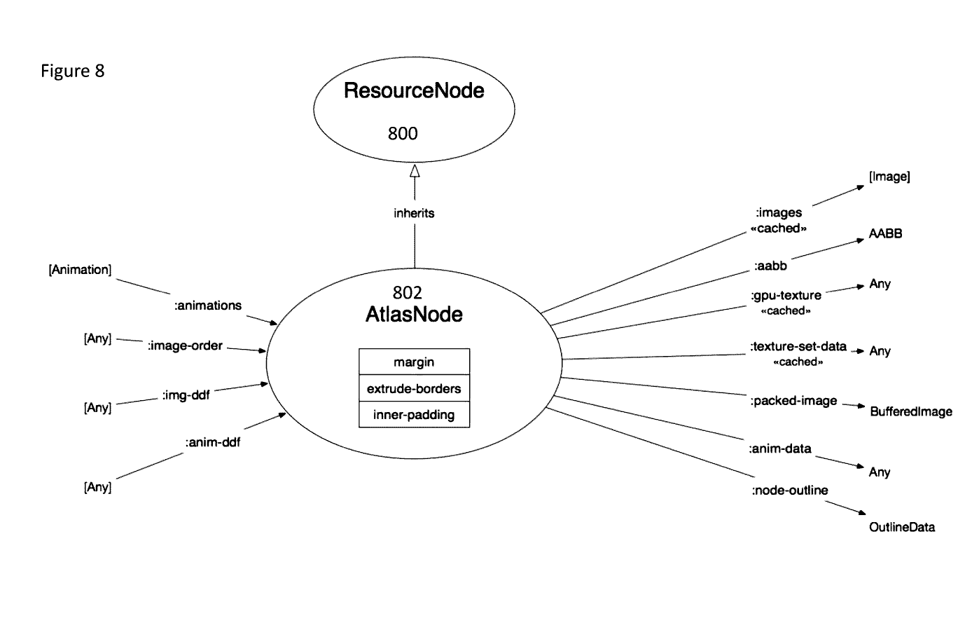

Reference is made to FIG. 7 which shows a method of an embodiment.

In step T1, data is received at a node via an arc from another node.

In step T2, the node uses the input data to determine an output.

In step T3, the node provided an output on an arc to another node.

In step T4, the output determined by the node is stored in cache, along with a flag to indicate that the data is valid. It should be appreciated that steps T3 and T4 may occur in any order or general at the same time.

In step T5, a change is made to the data. Going back to our simple example, the user via the software editor decides to make a change to hat data.

In step T6, the flag in the cache is updated to indicate that the data is invalid. This may be performed by the editor software.

It should be appreciated that in some embodiments, the dependency information can be used to determine when a re-computation is required. For example, using the simple example described above, the user decides to change the name of the hat file. That alone will not change any dependencies and accordingly, when that hat file needs to be used by other nodes, cached data can be used as re-computation of the hat file is not required. Changing the content of the file—to have a different hat would require re-computation by any node which receives the output from that node.

In some embodiments, a node will only provide the output when necessary. In other words if a changes is made to an upstream node, a downstream node will only be required to provide recomputed an updated output if required to do so.

Some embodiments provide the ability to trace dependencies below the node granularity level, i.e. determine that the cache entries should be invalidated depending on which parts of the nodes has changed, rather than that the nodes have changed. For example a node may provide two outputs. The editor may make some changes to the node which only changes one output. Only the data associated with the changed output needs to be marked as invalid in the cache. The unchanged data remains marked as valid in the cache.

For example, the user wants to view the scene provided by third node. It is determined by the editor software from the dependencies that data from the first and the second node is required. The editor software will check the cache to see if the data from the first and second node is already stored in the cache and if so the associated cache status of that data. If the data from the first data or the second data is marked as invalid, this means that the node needs to get recalculated data and cached data is not used. This may be controlled by the software editor or by the node.

If the first and second cached data is valid, a check can be made to see if the third node output is cached and valid. If so that cached value is provided as its output. If not, the third node can use the cached data to recalculate its output.

Since data needed to compute any value in the system is known because of the dependencies, when data is changed it is possible to provide 100% correct cache invalidation. Specifically, this is independent of any new computations or functions added to the system. As soon as a value is changed, its corresponding cache entry is marked as invalid. Any node which requires that data directly or indirectly will only use the data cache if the data is marked as valid. The software editor has knowledge of the dependencies and this is used by the software editor to determine for a particular node which particular data it is dependent on and from that the respective cache entries can be checked to see if they are valid. If the data is not valid, the upstream nodes are required to generate the data. Because of the dependency information it is known that if first node data is invalid, the second node data will also be invalid and so on.

The dependency information provides information about the particular data from a particular node a particular output of a node requires. This is done for directly and indirectly connected nodes.

In some alternative embodiments, the dependency information may only provide node relationships. For example, it is known that node 3 requires data from node 2 and 1 but not the particular data. In this scenario, when a change is made to a node, all the output data would need to be marked as invalid.

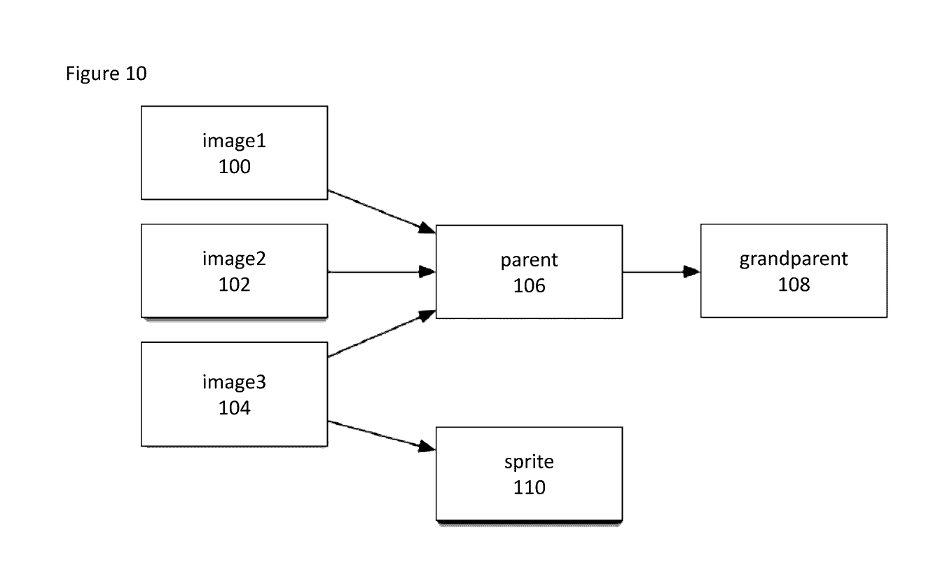

Reference is made to FIG. 10 which shows a parent node 105 which receives an input from an image1 node 100, image 2 node 102 and image 3 node 104. The parent node 106 provides an output to a grandparent node 108. In this example the image 3 node 104 also provides an input to a sprite node 110. If the output of the image 1 nodes 100 changes, this will invalidate the outputs from the image 1 node, parent node and grandparent node in the cache.

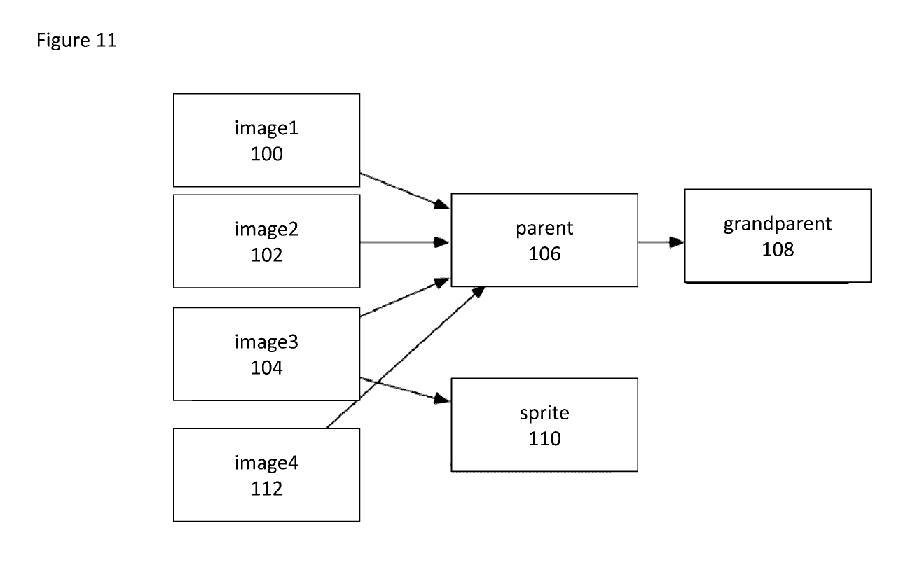

Reference is made to FIG. 11. FIG. 11 is similar to the arrangement of FIG. 10 except that a new input from image 4 node 112 has been provided to the parent node 106. Causing a new input to parent will cause its output to need to be recomputed. Therefore, the output values of the parent and grandparent node are invalidated in the cache.

It should be appreciated that the undo/redo function will also cause cache validation/invalidation to be set to that of the history selected. Say FIG. 10 (after the change to the image 1 node has been made) represents history 0 and FIG. 11 represents history 1. History will include the data stored in the cache along with the associated status. If the undo function is invoked, then the cache data and the associated validity will revert to that at the time history 0 is saved.

In some embodiments, building a game project is the process of converting the work-files of the game, into files used by the game engine to run the game on e.g. a mobile phone. Since the process of building is a part of the graph, incremental building is achieved. The building may be performed by one or more nodes which build the game.

For the same reason, save-all (saving every file in the project) is also incremental. This means that the first time the user does this, all files are saved to disk. The second time, only the files which have changed will be saved.

For the same reason, a scene is only re-rendered when something that affects the final rendering has changed. More specifically, when any data that does not affect the rendering has changed, no rendering is performed. When any data that does affect the rendering has changed, rendering is performed. This means it is both correct and optimal with respect to performance and computation.

In some embodiments one or more nodes may be copied. Where two or more nodes are copied, the arcs between the nodes will also be copied. The nodes can be pasted into a different part of the graph. The upstream connections may be copied. For example, a copied node will still have the same data input as the original node unless that is changed after the pasting in of the node.

For example a node provides a character may be copied. The copy node may receive the same input as the original node.

For illustration purposes only, some embodiments will be described in the context of computer implemented game. A game is composed of multiple pieces of data (an image, a game board, a welcome screen, a message to the user, etc.), which have relationships to each other. The parts are stored in multiple files, which contain references (or paths) to the file they relate to. These files are loaded into memory, where the files are represented by graph nodes (as described above) with arcs representing the relationships between the files.

Since any such data piece exists only once in memory, and all functionality depending on it use that same identical piece, “in-place editing” may be provided. This means that the piece of data can in fact be modified wherever it appears, and still be accurately updated in every other place it appears. This is not a manual process, it happens naturally as a result of the data model. Consider the following example. The user is editing via the editor software the man with the hat in the scene. The user is thus interacting with the third node although the man is associated with the second node and the hat is associated with the first node. In particular, the hat of the man is updated. This will mean that if the hat is used by any node that hat is also updated.

The data which is output by each node will include information identifying that node. The information may simply identify the node. In other embodiments the information may also identify the arc. The information identifying the node may be a node identity, address of the node or any other suitable information.

Thus when the hat data is being edited when the hat appears in the scene of the third node, the node information associated with the hat allows the data to be edited in the first node although it appears to the user that the data is being edited in the third node.

Consider the following example. There are two different scenes provided by different nodes which use the hat. Only one scene is activated at a time. The user, via the editor software, has activated the scene which can be viewed. The user, via the editor software, edits the hat. Because the hat data has the hat node information, the user is actually editing the hat in the hat node although the user is viewing the scene provided by the third node.

When the hat data has been altered, the cache entry for the hat data is marked with an invalid flag.

When the user activates the second scene which requires the hat data, the hat data has been marked as invalid because of the previous change. When it is accessed (from the second scene being activated), it is tested to see if it is invalid, and if so, recomputed. Thus the second scene will have the updated character automatically.

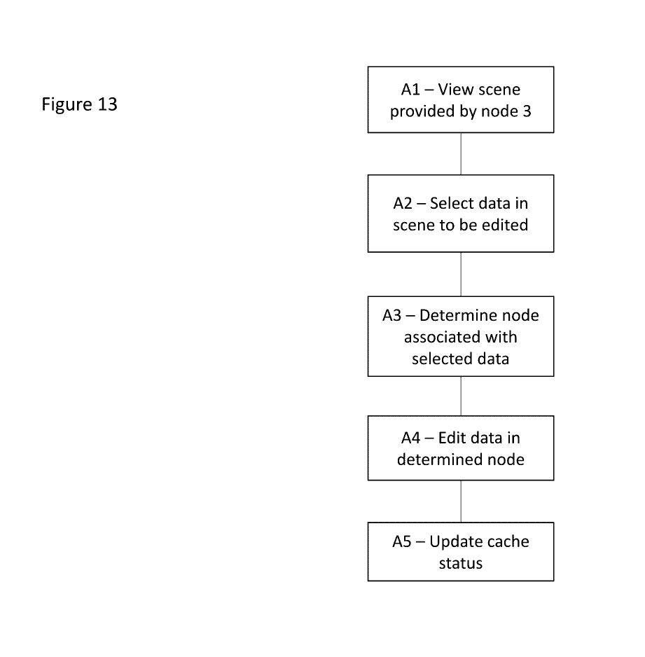

Reference is made to FIG. 13 which shows a method of an embodiment.

In step A1, the scene provided by the third node is viewed.

In step A2, the user, via the editor software, selects data in the scene to be edited. This is for example the hat.

In step A3, it is determined with which node the selected data is associated. This is ascertained from the information identifying the node.

In step A4, the editor software will edit the selected data at the identified node.

In step A5, the editing will cause the cache entry of the selected data to be updated to have the invalid status.

Some embodiments provide a unified content pipeline and editor application. A large number of the computations needed to turn the game content into a format consumable by the game engine on target devices are the same as the computations needed to view the game content when changing it in the editor. Since both are expressed through the same graph model expressed above, these computations are now unified and only needed to be performed once. This presents an optimization in that if the content has been viewed, it will be faster to compile and vice versa.

In some embodiments, it may be desirable to make changes to the logic of a node. In some embodiments, when a change is to be made to a node, that node will be added in as a new node rather than attempting to modify an existing node.

The software may be configured to determine when a new node is to replace the old node what connections or arcs were supported by the old node. The software will map the data which can be provided by the new node to provide the outputs or arcs which the new node is required to support. Likewise the software will map the data which is to be provided to the node to an appropriate input to the node.

Consider the example of the hat node which is to be replaced by a new hat node. The new node will have different logic. In this example, the new node will be required still to provide an output to the second node. Accordingly, the new node will map a hat output to the arc which is connected to the second node.

By allowing the software to define the inputs and/or outputs which are used to support respective arc, the process of modifying node logic may be simplified. If the inputs and outputs of the original node have to be supported, this can be difficult to implement.

The software will map the inputs, outputs and properties of the old node to inputs, outputs and properties of the new node.

It should be appreciated, that in some embodiments a new node may be added which has one or more different connections to the node which is being replaced.

In some embodiments, one or more additional nodes may be added in with new connections to one or more other nodes.

Some embodiments may have the advantage that since the game data is loaded into memory, the various function can be performed with minimal access of the hard drive. This, in some embodiments, may speed up the process significantly. The function may be any suitable function and may be one or more of viewing, compiling, undo or the like.

Some more detailed examples will now be described.

In some embodiments, the graph will pull an output with a node-value. A node value will be altered by a transact instruction. One example is given below.

(defn-play-handler [view-id]

| | |
|---|---|
| (let [play-mode | (g/node-value view-id :play-mode) |
| updatables | (g/node-value view-id :selected-updatables) |
| new-play-mode | (if (=play-mode :playing) :idle :playing) |
| active-updatable-ids | (g/node-value view-id :active-updatables-ids) |

new-active-updatable-id (if (empty? active-updatable-ids) (keys updatables) active-
updatable-ids)]
(g/transact
(concat
(g/set-property view-id :play-mode new-play-mode)
(g/set-property view-id :active-updatable-ids new-active-updatable-ids)))))

In some embodiment, micro language may be used to define node types in the dataflow. This may be a primary means of extension.

A simple node definition is given below.

| (g/defnode CodeView | |
|---|---|
| (property text-area | TextArea) |
| (input code-node | g/Int) |
| (input code | g/Str) |
| (input caret-position | g/Int) |
| (output new-content | g/Any :cached update-text-area)) |

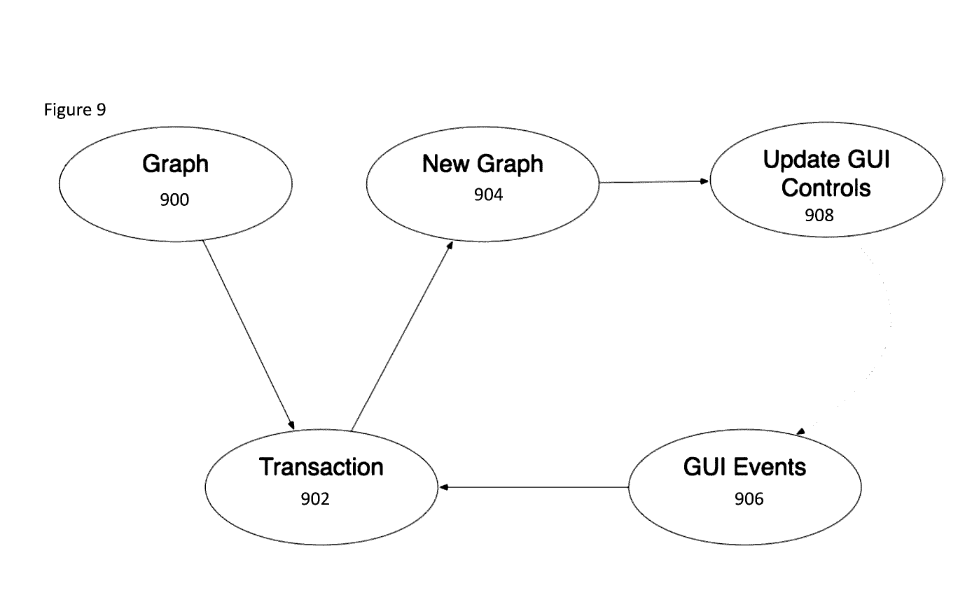

FIG. 8 shows an example with a resource node 80 and an atlas node 82. The inputs to a node are typed according to the value which they take. It is not dependent on the type of node at the end of the arc. In the example show, the input types are animation, image order, image ddf (data definition file) and animation ddf. The outputs declare the type of value they produce. The output types shown in the example may be cached images, axis-aligned bounding box (AABB), gpu (graphic processing unit) texture, texture set data, packed image, animation data and node outline. It should be appreciated that any input is also an output and vice versa. As can be seen some of the inputs and outputs are marked “any”. This means that there is no declared constraint. Some of the outputs/inputs do have constraints such as image, AABB, buffered image, outline data, animation. This will refer to the node properties of the respective node outputting the data and the respective nodes receiving the data.

The number of inputs and outputs are by way of example as are the types of the inputs and outputs.

These inputs are provided to an atlas node which provided margins, extruding of borders and inner padding. A resource node is shown from which the atlas node inherits the properties of the atlas node.

(g/defnode AtlasNode
(inherits project/ResourceNode)
(property margin g/Int ,,,)
(property inner-padding g/Int ,,,)
(protery extrude-borders g/Int ,,,)
(input animations Animation :array)
(input img-ddf g/Any :array)
(input anim-ddf g/Any :array)
(input image-order g/Any :array)

| | | |
|---|---|---|
| (output images | [Image] | :cached (g/fnk [animations] ,,,)) |
| (output aabb | AABB | (g/fnk [texture-set-data] ,,,)) |
| (output gpu-texture | g/Any | :cached (g/fnk [_node-id texture-set-data] ,,,)) |
| (output texture-set-data | g/Any | :cached produce-texture-set-data) |
| (output packed-image | Buffered image | (g/fnk [texture-set-data] ,,,)) |
| (output anim-data | g/Any | :cached produce-anim-data) |
| (output node-outline | outline/OutlineData | :cached (g/fnk [_node-id child-outlines] ,,,)) |
| (output save-data | g/Any | :cached produce-save-data) |
| (output build-targets | g/Any | :cached produce-build-targets) |
| (output scene | g/Any | :cached produce-scene)) |

Note the cached data associated with an output.

Transactions allow state to be changed. Atomic state advancement is supported. A caller may build a nested collection of transaction steps.

Consider the following example where transactions are provided a pure functions.

The transaction on the left returns the data on the right.

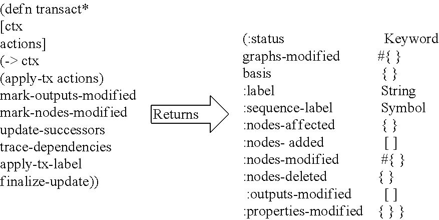

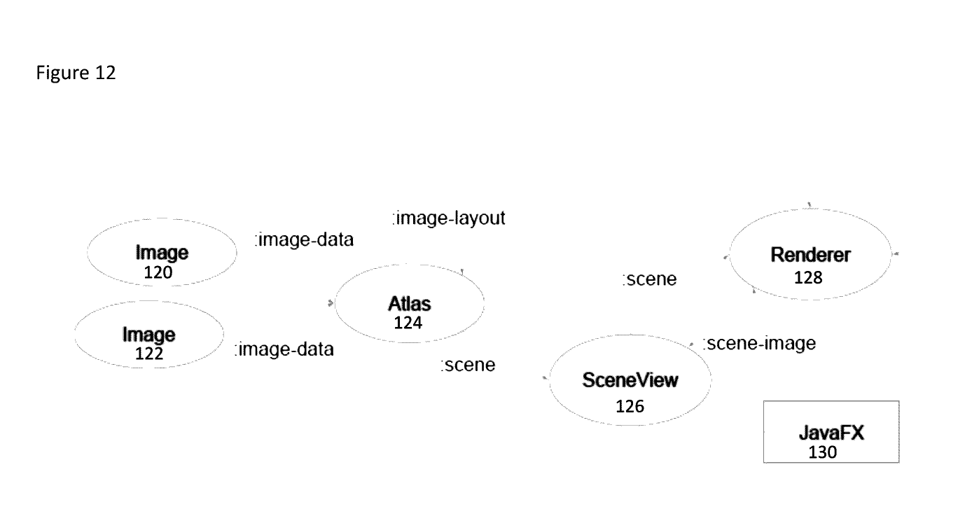

Reference is made to FIG. 12 which shows an embodiment which uses production functions. The atlas node 124 is configured to receive first image data from a first image node 120 and second image data from a second node 122. The scene output provided by the atlas node 124 is provided to a scene view node 126. The scene node provides the scene to a renderer node 128 which provides the scene image to the scene node. Java FX 130 may be used. This software provides a platform for delivering desktop applications.

In some embodiments, the nodes can be connected to a user interface. The graph end-points may be connected to a user interface. The nodes can be pulled at a “responsive” frequency. UI widgets can be recreated from data description, optionally with additional pre-processing.

Consider the example of connecting nodes to the UI outline.

{:_node-id 1
:label “Collection”
:icon “collection.png”
:children [{:_node-id 2 . . . }]}

This gives:

Outline
Collection
ground (/level/ground.collection)
bg
controller
hero (/hero/hero.go)
collisionobject
deathfx (/particles/death/partic
emitter
radial
script (/hero/hero.script(
spinemodel
hud

Various methods and devices have been described. It should be appreciated that these methods may be implemented in apparatus or devices comprising any suitable circuitry. Some embodiments may be implemented by at least one memory and at least one processor. The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

Various methods and devices have been described. It should be appreciated that these methods may be implemented in apparatus or devices comprising any suitable circuitry. Some embodiments may be implemented by at least one memory and at least one processor.

The memory is provided by memory circuitry and the processor is provided by processor circuitry. Some embodiments may be provided by a computer program running on the at least one processor. The computer program may comprise computer implemented instructions which are stored in the at least one memory and which may be run on the at least one processor.

An appropriately adapted computer program code product or products may be used for implementing the embodiments, when loaded on an appropriate data processing apparatus. The program code product for providing the operation may be stored on, provided and embodied by means of an appropriate carrier medium. An appropriate computer program can be embodied on a computer readable record medium. A possibility is to download the program code product via a data network.

In general, the various embodiments may be implemented in hardware or special purpose circuits, software, logic or any combination thereof.

Embodiments may thus be practiced in various components such as integrated circuit modules.

It is also noted herein that while the above describes embodiments of the invention, there are several variations and modifications which may be made to the disclosed solution without departing from the scope of the present invention.

1. A computer implemented method comprising:
responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs;
responsive to a further change in data in the node graph architecture, storing in the memory a second full history of the graph; and
applying an undo function such that a current state of the node graph architecture reverts to the state of the first history.

2. A method as claimed in claim 1 comprising wherein a data structure of the node graph architecture comprises a persistent immutable data structure.

3. A method as claimed in claim 2, wherein at least two of the histories share at least some data structures.

4. A method as claimed in claim 1, comprising storing, for each change in data a further full history of the graph.

5. A method as claimed in claim 4, wherein n full histories are stored and using the undo function a mth full history provides a current state of the node graph architecture, the method further comprising responsive to a further change to the mth full history, deleting any history which occurred in time after an initial occurrence of the mth full history.

6. A method as claimed in claim 1, comprising applying a redo function such that a state of the node graph architecture changes to a state of the graph history which occurred subsequent to the initial occurrence of a current graph history.

7. A method as claimed in claim 1, wherein the state information comprises cache data comprising an output value of a node and validity information indicating if the output value is valid, the undo function causing the cache data to revert to a respective value in the respective history.

8. A method as claimed in claim 1, wherein each history is stored with identification information.

9. A method as claimed in claim 1, comprising
determining a plurality of output data in response to input data in a respective node;
storing the plurality of output data in a cache memory with information indicating the validity of the respective data;
editing at least one node such that at least one of the respective output data is changed; and
causing the information indicating the validity of the data which is changed to indicate that the data is invalid.

10. A method as claimed in claim 9, using information about dependencies, the dependencies providing information about which used outputs from one or more other nodes a respective node at least one of directly and indirectly uses, the information being used when the respective node is required to provide an output to check the validity information associated with the used outputs and determining from the validity information being used to determine if the used output data in the cache memory is to be used.

11. A method as claimed in claim 1, comprising selecting data used by a current node, the current node using output data from a plurality of different nodes, each of the output data comprising information identifying the node which provided the output data, said selected data being one of said output data; and using the identifying information to perform editing of the selected data in the node of the different nodes which provided the data while viewing the data in the node.

12. A data processing apparatus comprising at least one processor and at least one memory coupled to the processor, said at least one memory having program code configured to be executed by the at least one processor to implement a method, said method comprising:
responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs;
responsive to a further change in data in the node graph architecture, storing in the memory a second full history of the graph; and
applying an undo function such that a current state of the node graph architecture reverts to the state of the first history.

13. A data processing apparatus as claimed in claim 12, wherein said a data structure of the node graph architecture may comprise a persistent immutable data structure.

14. A data processing apparatus as claimed in claim 13, wherein at least two of the histories may share at least some data structures.

15. A data processing apparatus as claimed in claim 12, wherein the at least one memory is configured to store, for each change in data a further full history of the graph.

16. A data processing apparatus as claimed in claim 12, wherein n full histories are stored and using the undo function a mth full history provides a current state of the node graph architecture, the at least one processor being responsive to a further change to the mth full history, to delete any history from said memory which occurred in time after an initial occurrence of the mth full history.

17. A data processing apparatus as claimed in claim 12, wherein the processor is configured to apply a redo function such that a state of the node graph architecture changes to a state of the graph history which occurred subsequent to the initial occurrence of a current graph history.

18. A data processing apparatus as claimed in claim 12, wherein the state information comprises cache data comprising an output value of a node and validity information indicating if the output value is valid, the undo function causing the cache data to revert to a respective value in the respective history.

19. A data processing apparatus as claimed in claim 12, wherein said at least one memory is configure to store each history with identification information.

20. A computer program product, comprising a computer readable storage device having a computer readable program code stored therein, said computer readable program code containing instructions configured to be executed by at least one processor to implement a method, said method comprising:
responsive to a change in data of a node in a node graph architecture, storing in memory a first full history of a graph of the node graph architecture, the history comprising state, wherein the node graph architecture comprises a plurality of nodes with respective arcs there between, the state comprising data of the nodes and the arcs;
responsive to a further change in data in the node graph architecture, storing in the memory a second full history of the graph; and
applying an undo function such that a current state of the node graph architecture reverts to the state of the first history.
